(19) United States
(12) Patent Application Publication
(10) Pub. No.: US 2016/0195259 A1
(43) Pub. Date: Jul. 7, 2016

(54) SWIVELING CANDLE HOLDER AND PRESERVER

(71) Applicant: Julie McCulloch Burton, Bellingham, WA (US)

(72) Inventor: Julie McCulloch Burton, Bellingham, WA (US)

(21) Appl. No.: 14/588,582

(22) Filed: Jan. 2, 2015

(51) Int. Cl. F21V 35/00; F21V 15/00; F21S 13/12

(52) U.S. Cl. CPC F21V 35/00; F21S 13/12; F21V 15/00; F21W 2121/00

(57) ABSTRACT

Some embodiments of the present disclosure include a candle holder and preserver for preventing a wick and a cauldron of the candle from getting wet by falling moisture, such as rain or shower water. The candle holder and preserver may include a base, a pair of support arms extending upwards from the base, a pair of bracket arms pivotally attached to the pair of support arms, and a candle support configured to secure a candle attached to and extending between the pair of bracket arms, the candle support comprising a holder configured to accommodate and hold a candle. The bracket arms may be configured to swivel the candle support from an upright position to an inverted position.

### BACKGROUND

The embodiments herein relate generally to candles, and more particularly, to a swiveling candle holder and preserver for use, for example, in the shower or outdoors.

Candles have to be removed from a tub when the shower is used, because, if left there, the cauldron fills up and the wick gets wet, rendering the candle unsuitable for use. Similarly, outdoor candles have to be brought indoors when rain or other precipitation is expected or else the wick may get wet and the cauldron may fill up. Candle holders that aim to address this problem include glass jars, which completely enclose the candle and decorative candle lanterns, which are not water-tight.

Therefore, what is needed is a candle holder that can also preserve the candle and prevent the wick or cauldron from getting wet.

### SUMMARY

Some embodiments of the present disclosure include a candle holder and preserver for preventing a wick and a cauldron of the candle from getting wet by falling moisture, such as rain or shower water. The candle holder and preserver may include a base, a pair of support arms extending upwards from the base, a pair of bracket arms pivotally attached to the pair of support arms, and a candle support configured to secure a candle attached to and extending between the pair of bracket arms, the candle support comprising a holder configured to accommodate and hold a candle. The bracket arms may be configured to swivel the candle support from an upright position to an inverted position.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present invention shown with an exemplary candle in an upright position.

FIG. 2 is a perspective view of one embodiment of the present invention shown with an exemplary candle in an inverted position.

FIG. 3 is an exploded view of one embodiment of the present invention.

FIG. 4 is a section view of one embodiment of the present invention, taken along line 4-4 in FIG. 1.

FIG. 5 is a section view of one embodiment of the present invention, taken along line 5-5 in FIG. 4.

FIG. 6 is a perspective view of one embodiment of the present invention.

FIG. 7 is a section view of one embodiment of the present invention, taken along line 7-7 in FIG. 6.

FIG. 8 is a section view of one embodiment of the present invention.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used to hold a candle and prevent a candle from having damage caused by moisture and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

1. Base

2. Support Arms

3. Bracket Arms

4. Shelf

5. Swivel

The various elements of the candle holder for preserving a candle and preventing the wick and cauldron of the candle from getting wet of the present disclosure may be related in the following exemplary fashion. It is not intended to limit the scope or nature of the relationships between the various elements and the following examples are presented as illustrative examples only.

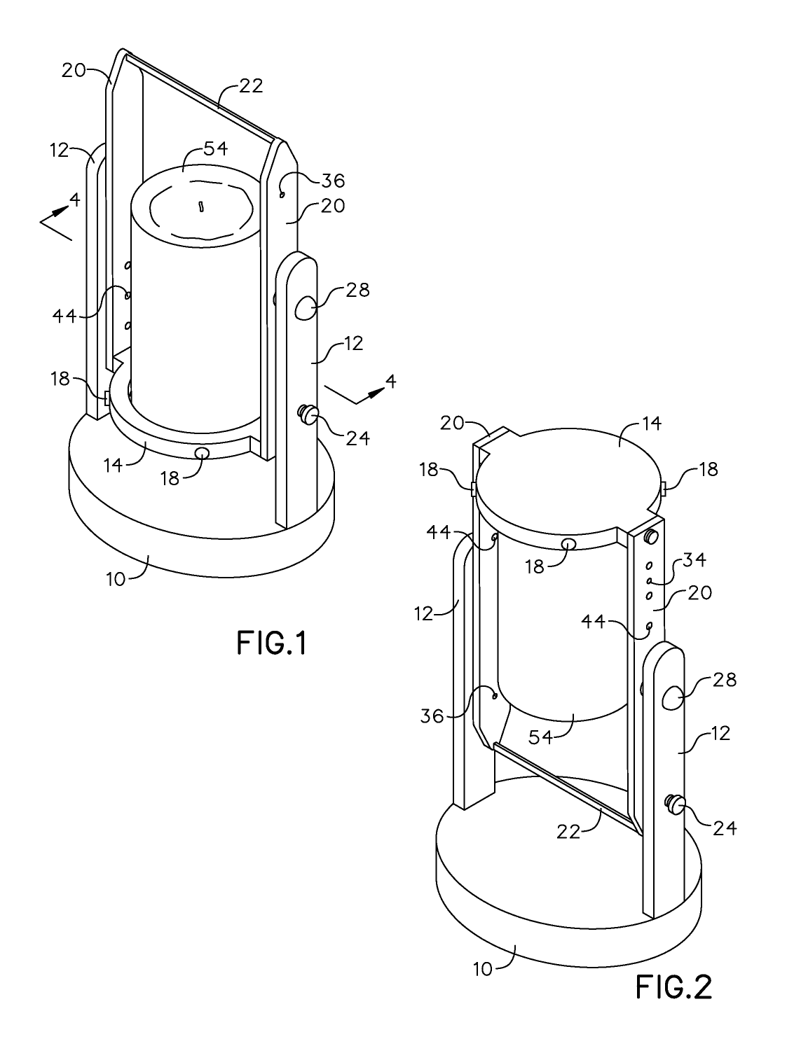

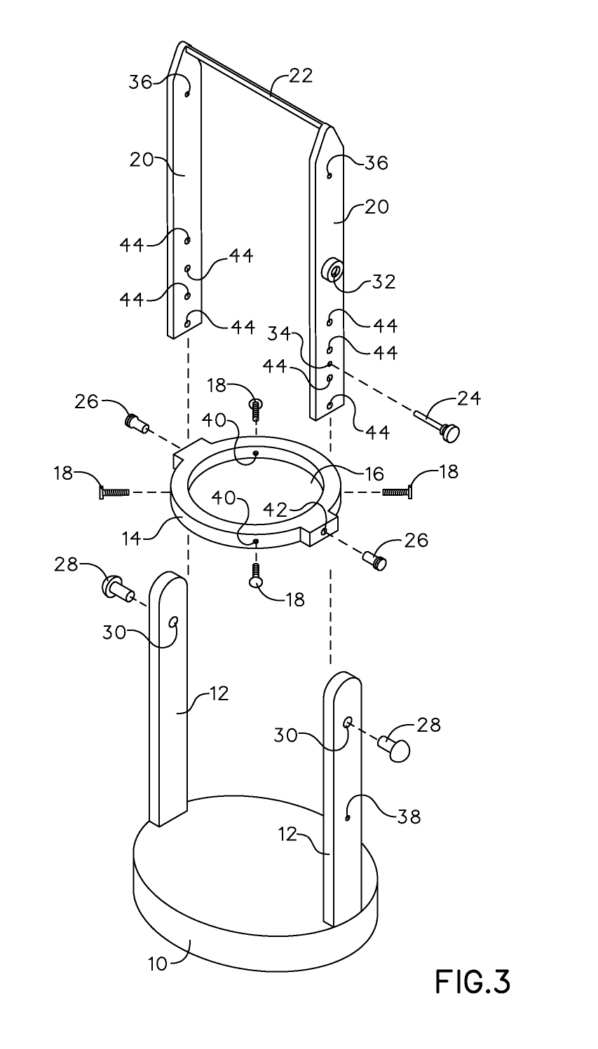

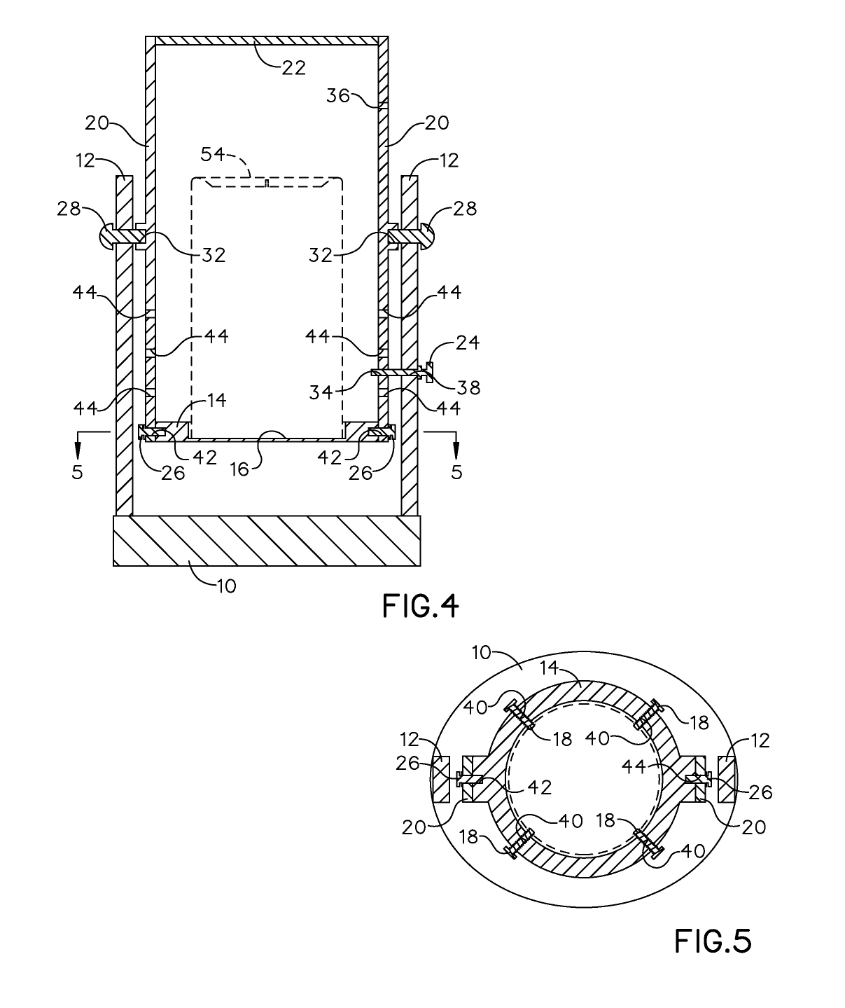

By way of example, and referring to FIGS. 1-8, some embodiments of the candle holder and preserver of the present disclosure comprise a base 10, a pair of support arms 12 extending substantially perpendicularly upwards from the base 10, a pair of bracket arms 20 pivotally attached to the pair of support arms 12, a candle support attached to and extending between the pair of bracket arms 20, and a holder configured to accommodate and hold a candle 54, wherein the pair of bracket arms 20 is configured to swivel to (i) hold the candle support in an upright position, as shown in FIG. 1, and (ii) hold the candle support in an inverted position, as shown in FIG. 2, as desired. When the candle support is held in an upright position, a candle 54 placed thereon may be situated in a useable configuration, and when the candle support is held in an inverted position, a candle 54 may be protected from its wick or cauldron getting wet by, for example, shower water or rain water.

In some embodiments, the candle support may be adjustably attached to the bracket arms 20 using, for example, a pair of shelf pins 26. The shelf pins 26 may each extend through a bracket shelf pin hole 44 spaced along a length of each of the bracket arms 20 and engage with a shelf pin hole 42 in the candle support. For example, the bracket arms 20 may each have about 3 bracket shelf pin holes 44 configured to engage with the shelf pins 26, wherein the bracket shelf pin holes 44 on each bracket arm 20 may align with the corresponding bracket shelf pin holes 44 on the other bracket arm 20, such that the shelf 14 is substantially level.

In some embodiments, and as shown in FIGS. 1-5, the candle support may comprise a shelf 14 having a candle slot 16 configured to accommodate a candle 54, wherein the candle 54 may be removably secured within the candle slot 16. For example, the shelf 14 may have a plurality of retaining screw holes 40, wherein a retaining screw 18 is configured to be threaded through each retaining screw hole 40 and into the candle 54, securing the candle 54 to the shelf 14.

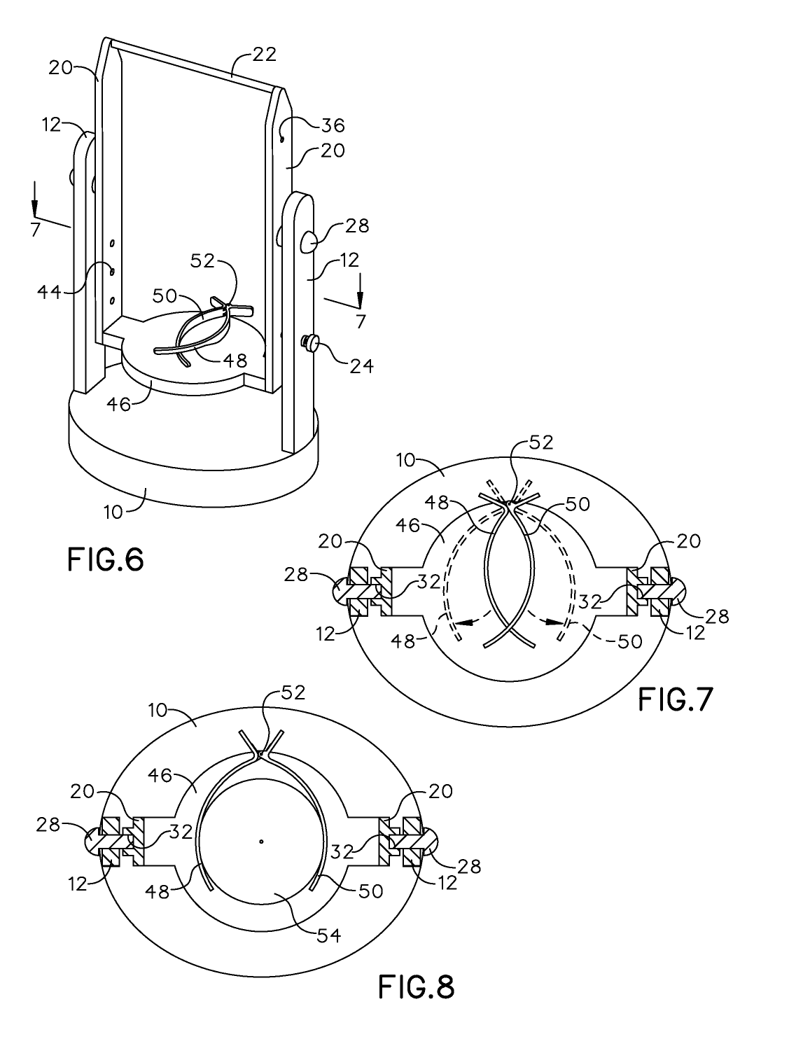

Alternatively, as shown in FIGS. 6-8, the candle support may comprise a shelf 46 having a candle clamp attached thereto, wherein the candle clamp comprises a first clamp arm 48 and a second clamp arm 50 operatively attached via a clamp spring 52, wherein the first clamp arm 48 and the second clamp arm 50 are configured to open and close, securely accommodating a candle 54 within the clamp.

In embodiments, the candle supporter may be secured in its desired position using a locking mechanism, such as a locking pin 24 configured to engage with both a bracket locking pin orifice and a base locking pin orifice 38. For example, when the candle 54 is positioned in an upright position, as shown in FIG. 1, the locking pin 24 may extend through the base locking pin orifice 38 and through a lower bracket locking pin orifice 24, wherein the two orifices are concentrically aligned. Similarly, when the candle 54 is positioned in an inverted configuration, as shown in FIG. 2, the locking pin 24 may extend through the base locking pin orifice 38 and through an upper bracket locking pin orifice 36, wherein the two orifices are concentrically aligned. Thus, the bracket arm 20 may comprise a pair of locking pin orifices 34, 36 that each align with the base locking pin orifice 24 when the candle support is in an upright position and inverted configuration, respectively.

As mentioned above, the bracket arms 20 may be pivotally attached to the support arms 12. For example, the bracket arms 20 may comprise a pair of swivel post slots 32, each configured to engage with a swivel post 28. The swivel post 28 may be inserted into and pass through a swivel post orifice 30 in the support arm 12 to engage with a swivel post slot 32 in the bracket arm 20, resulting in the bracket arms 20 being pivotally attached to the support arms 12 such that the bracket arms 20 can rotate 360° about the swivel post 28.

In some embodiments, a spreader bar 22 may extend from a first support arm 20 to a second support arm 20 at an end of the support arms 20 distal from the candle support. The spreader bar 22 may help keep the spreader arms 20 from leaning inward toward a candle 54 or from leaning outwards away from the candle 54.

To use the device of the present invention, a user would secure a candle 54 within the candle support, and use the candle 54 as normal. When the user wanted to protect the wick and cauldron, the user would invert the candle 54 by swiveling the bracket arms 20 180° and securing the device in the inverted position by engaging the locking pin 24 with the upper bracket locking pin orifice 36 and the base locking pin orifice 38. When the user was ready to use the candle 54 again, the user would simply remove the locking pin 24, swivel the bracket arms 20 180° to its upright position and lock the device in the upright position using the locking pin 24.

In some embodiments, the device may further comprise a motor and an electronic controller, such that the candle holder can be inverted electronically.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A candle holder and preserver for preventing a wick and a cauldron of the candle from getting wet by falling moisture, the candle holder and preserver comprising:
a base;
a pair of support arms extending upwards from the base;
a pair of bracket arms pivotally attached to the pair of support arms; and
a candle support configured to secure a candle attached to and extending between the pair of bracket arms, the candle support comprising a holder configured to accommodate and hold a candle,
wherein:
the pair of bracket arms is configured to swivel the candle support from an upright position to an inverted position.

2. The candle holder and preserver of claim 1, further comprising a locking mechanism configured to lock the pair of bracket arms in their desired position.

3. The candle holder and preserver of claim 2, wherein:
at least one of the support arms comprises a base locking pin orifice;
at least one of the bracket arms comprises:
a lower bracket locking pin orifice configured to align with the base locking pin orifice when the candle support is in the upright position; and
an upper bracket locking pin orifice configured to align with the base locking pin orifice when the candle support is in the inverted position; and
the locking mechanism comprises a locking pin configured to engage with the base locking pin orifice and one of the lower bracket locking pin orifice and the upper bracket locking pin orifice to secure the candle support in its desired position.

4. The candle holder and preserver of claim 1, wherein:
the candle support comprises a shelf having a candle slot configured to accommodate a candle; and
the candle is removably secured within the candle slot.

5. The candle holder and preserver of claim 4, wherein:
the shelf comprises a plurality of retaining screw holes; and
a retaining screw is configured to be threaded through each retaining screw hole and into the candle, securing the candle to the shelf.

6. The candle holder and preserver of claim 1, wherein:
the candle support comprises a shelf having a candle clamp attached thereto;
the candle clamp comprises a first clamp arm and a second clamp arm operatively attached to one another via a clamp spring; and
the first clamp arm and the second clamp arm are configured to open and close, securely accommodating the candle within the clamp.

7. The candle holder and preserver of claim 1, wherein:
the bracket arms each comprise a swivel post slot configured to engage with a swivel post; and
the swivel post is configured to be inserted into and pass through a swivel post orifice in the support arm to engage with the swivel post slot in the bracket arm, resulting in the bracket arms being pivotally attached to the support arms such that the bracket arms can rotate 360° about the swivel post.

8. The candle holder and preserver of claim 1, wherein:
the candle support is adjustably attached to the bracket arms using pair of shelf pins;
the shelf pins each extend through a bracket shelf pin hole spaced along a length of each of the bracket arms and engage with a shelf pin hole in the candle support.

9. The candle holder and preserver of claim 8, wherein the bracket arms each have about 3 bracket shelf pin holes configured to engage with the shelf pins, such that the candle support can be supported at a plurality of heights along the bracket arms.
